(19) United States
(12) Patent Application Publication
(10) Pub. No.: US 2026/0151993 A1
(43) Pub. Date: Jun. 4, 2026

(54) LIQUID DISCHARGE HEAD, LIQUID SUPPLY APPARATUS, AND ARTICLE MANUFACTURING METHOD

(71) Applicant: CANON KABUSHIKI KAISHA, Tokyo (JP)

(72) Inventors: YUYA INOMATA, Tochigi (JP); MASAHIRO ITO, Tochigi (JP)

(21) Appl. No.: 19/400,617

(22) Filed: Nov. 25, 2025

(30) Foreign Application Priority Data
Dec. 2, 2024 (JP) 2024-209750

(51) Int. Cl. B41J 2/045; B41J 2/21; B41J 25/00

(52) U.S. Cl. CPC B41J 2/04505; B41J 2/04551; B41J 2/04568; B41J 2/2135; B41J 25/003; B41J 2/04586

(57) ABSTRACT

The present disclosure provides a liquid discharge head including a discharge surface, wherein m discharge outlet arrays are provided on the discharge surface, each discharge outlet array is formed by arraying, at a pitch A in one direction, a plurality of discharge outlets each configured to discharge a droplet, and the m discharge outlet arrays are arranged while being shifted in the one direction by a first distance d₁ and in a direction perpendicular to the one direction by a second distance d₂, and in each of a first posture in which the one direction is parallel to a predetermined direction and a second posture in which the one direction is inclined at an angle θ with respect to the predetermined direction, the discharge outlets across all the m discharge outlet arrays are arranged at equal intervals in the predetermined direction.

### BACKGROUND

### Field of the Technology

The present disclosure relates to a liquid discharge head, a liquid supply apparatus, and an article manufacturing method.

### Description of the Related Art

Recently, an attempt has been made to form (that is, pattern) a pattern on a substrate using a liquid supply apparatus that supplies (applies or arranges), as droplets, a liquid that is a material of a functional element onto the substrate by an inkjet method when manufacturing various functional elements. Such patterning using the liquid supply apparatus has merits that the use efficiency of a material is high since on-demand patterning is possible, the size of a manufacturing apparatus is relatively small because of a non-vacuum process, and it is possible to apply a material over a large area at a high speed. For example, the liquid supply apparatus can be used to manufacture a display device such as a flat panel display. There have been proposed various display methods for a display device. In recent years, a display device using an organic Electroluminescence (EL) element has been developed actively. Since an organic EL material used to create an organic EL element is expensive, the liquid supply apparatus that has high efficiency of using a material and can apply the material over a large area at a high speed is effectively used to create an organic EL element.

The liquid supply apparatus supplies a liquid onto a substrate by controlling discharge of a droplet from each nozzle while relatively scanning the substrate and a head in which a plurality of nozzles (discharge outlets) that discharge droplets are arrayed. At this time, by inclining the head with respect to a scanning direction and changing the pitch of the nozzles in a direction perpendicular to the scanning direction, it is possible to adjust the pitch (that is, the resolution) of the droplets supplied onto the substrate. Japanese Patent Laid-Open Nos. 2021-194911 and 2006-289322 each discuss a configuration for changing the pitch of a plurality of nozzles in a direction perpendicular to a scanning direction.

In the head, a plurality of nozzle arrays in each of which a plurality of nozzles are arrayed at a predetermined pitch in one direction may be arranged while being shifted from each other. In this case, if an angle at which the head is inclined with respect to the scanning direction is not taken into consideration, it is impossible to arrange the nozzles at equal intervals in a direction perpendicular to the scanning direction, and it may become difficult to arrange droplets at equal intervals on the substrate. That is, unevenness may occur in supply of the droplets on the substrate.

### SUMMARY

The present disclosure provides a technique advantageous in accurately supplying droplets onto a substrate.

An aspect of the present disclosure provides a liquid discharge head that includes a discharge surface and m discharge outlet arrays provided on the discharge surface. Each discharge outlet array is formed by arraying, at a pitch A in one direction, a plurality of discharge outlets each configured to discharge liquid as respective droplets. The m discharge outlet arrays are arranged while being shifted in the one direction by a first distance d₁, in a direction perpendicular to the one direction by a second distance d₂. In each of a first posture in which the one direction is parallel to a predetermined direction and a second posture in which the one direction is inclined at an angle θ with respect to the predetermined direction, the discharge outlets across the m discharge outlet arrays are arranged at equal intervals in the predetermined direction, d₁=A/m, and d₂=2n·d₁/tan θ.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the present disclosure, illustrate embodiments of the present disclosure, and together with the description, serve to explain the principles of the embodiments.

FIG. 1 is a schematic view showing an example of the configuration of a liquid supply apparatus according to the first embodiment;

FIG. 2 is a flowchart illustrating an operation sequence of the liquid supply apparatus;

FIGS. 3A and 3B are views each showing an example of the arrangement of nozzles on a discharge surface of a liquid discharge head;

FIG. 4 is a view showing an example of the arrangement of a plurality of target regions on a substrate;

FIG. 5 is a view showing an example of the arrangement of a plurality of target regions on the substrate;

FIGS. 6A and 6B are views each showing an example in which a discharge process is performed using a liquid discharge head for the target regions of R pixels on the substrate shown in FIG. 4;

FIGS. 7A and 7B are views each showing an example in which a discharge process is performed using the liquid discharge head for the target regions of R pixels on the substrate shown in FIG. 5; and

FIGS. 8A and 8B are views each showing an example in which a discharge process is performed using the liquid discharge head for the target regions of G pixels on the substrate shown in FIG. 5.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present disclosure and the accompanying drawings, directions will typically be indicated on an XYZ coordinate system in which a surface parallel to a horizontal surface (the arrangement surface of a substrate or the discharge surface of a liquid discharge head) is defined as the X-Y plane. Directions parallel to the X-axis, the Y-axis, and the Z-axis of the XYZ coordinate system are the X direction, the Y direction, and the Z direction, respectively. A rotation about the X-axis, a rotation about the Y-axis, and a rotation about the Z-axis are θX, θY, and θZ, respectively. Control or driving (movement) concerning the X-axis, the Y-axis, and the Z-axis means control or driving (movement) concerning a direction parallel to the X-axis, a direction parallel to the Y-axis, and a direction parallel to the Z-axis, respectively. In addition, control or driving concerning the θX-axis, the θY-axis, and the θZ-axis means control or driving concerning a rotation about an axis parallel to the X-axis, a rotation about an axis parallel to the Y-axis, and a rotation about an axis parallel to the Z-axis, respectively.

### First Embodiment

A liquid supply apparatus 1 according to the first embodiment of the present disclosure will be described. The liquid supply apparatus 1 is an apparatus that forms a pattern on a substrate by discharging (supplying or applying), as droplets, a liquid that is a material of a functional element onto the substrate. The liquid supply apparatus 1 is sometimes called a liquid discharge apparatus or an inkjet apparatus, and functions as a substrate processing apparatus that processes a substrate for a semiconductor or a display panel. For example, the liquid supply apparatus 1 can be used to manufacture a display device such as a flat panel display or an Organic Light Emitting Diode (OLED) device. Liquid supplied onto the substrate by the liquid supply apparatus 1 may be referred to as a liquid herein. The liquid is sometimes called ink, and components thereof are not particularly limited. However, for example, the liquid can contain, for example, a solute and a solvent for forming an organic film on the substrate.

### [Example of Configuration of Liquid Supply Apparatus]

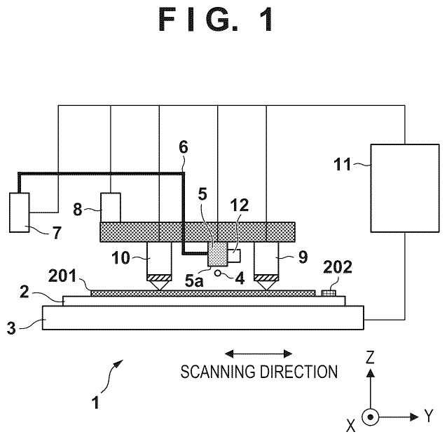

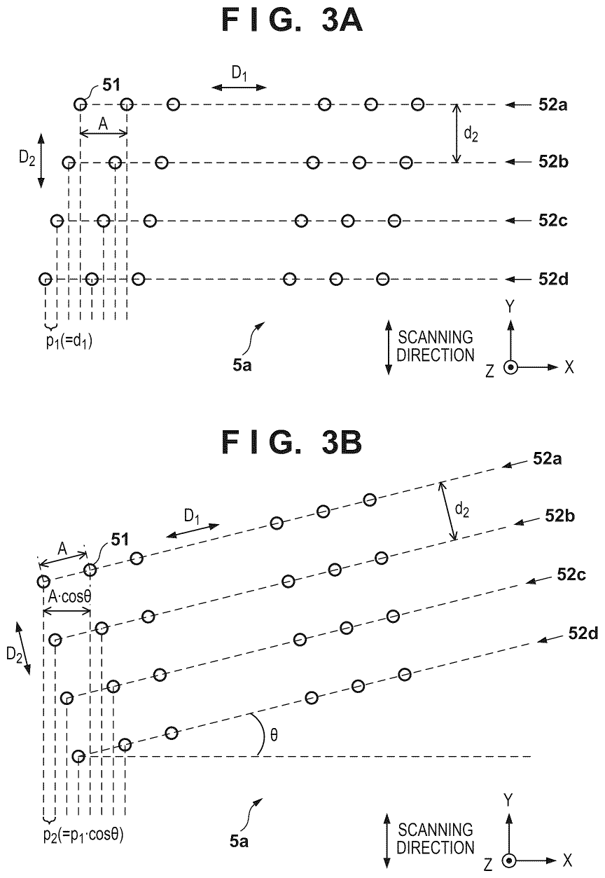

FIG. 1 is a schematic view showing an example of the configuration of the liquid supply apparatus 1 according to this embodiment, and can be used to explain the basic configuration and operation principle of the liquid supply apparatus 1. The liquid supply apparatus 1 includes a liquid discharge head 5 in which a plurality of discharge outlets 51 each for discharging a liquid as a droplet 4 are provided, and performs a discharge process of causing the liquid discharge head 5 (each discharge outlet 51, FIGS. 3A-3B) to discharge the droplet 4 while relatively scanning the liquid discharge head 5 and a substrate 2 in a scanning direction (Y direction). In this discharge process, discharge of the droplet 4 from the liquid discharge head 5 is repeatedly performed a plurality of times. This can supply (apply or arrange) the plurality of droplets 4 onto the substrate 2 in a desired distribution. The discharge process can be performed for one substrate 2 once or a plurality of times.

The liquid supply apparatus 1 includes, for example, a substrate stage 3 that moves while holding the substrate 2 of a display panel. The substrate 2 can be selected from a glass substrate, a plastic substrate, and the like in accordance with a target product to be manufactured. The substrate 2 is typically a plate-like member, but is not limited to a specific shape as long as it can function as a substrate. For example, the substrate 2 may be a deformable film or a disk-like substrate. On the substrate 2 on the substrate stage 3, a pixel area 201 where an array of a number of display pixels is formed by supplying a liquid (droplets) and an evaluation area 202 where a liquid is supplied for testing purposes to evaluate the state of the liquid (droplets) can be provided.

The liquid supply apparatus 1 includes the liquid discharge head 5 that can discharge the liquid as the droplets 4 toward the substrate 2, a tank 7 that stores the liquid, and a liquid supply system 6 that supplies the liquid from the tank 7 to the liquid discharge head 5. The liquid discharge head 5 includes, on a discharge surface 5a (for example, a lower surface facing the substrate 2), the plurality of discharge outlets 51 each for discharging the liquid as the droplet 4 in accordance with a driving signal, and discharge of the droplet 4 from each discharge outlet 51 is individually controlled by a controller 11. This can supply (apply) the droplets 4 in a desired distribution in the pixel area 201 on the substrate 2. Each discharge outlet 51 can be formed as, for example, a nozzle that discharges the droplet 4. The discharge outlet 51 may be referred to as the nozzle 51 herein. The detailed configuration of the liquid discharge head 5 will be described later. The tank 7 may be arranged inside or outside the liquid supply apparatus 1. The liquid supply apparatus 1 further includes a recovery unit 8 that recovers the discharge characteristic by performing a cleaning process and the like for the liquid discharge head 5.

The liquid supply apparatus 1 includes a driving mechanism 12 that drives the liquid discharge head 5. The driving mechanism 12 can adjust the inclination amount of the liquid discharge head 5 with respect to the scanning direction by rotationally driving the liquid discharge head 5 in the θZ direction within the plane parallel to the discharge surface 5a (that is, the surface of the substrate 2) of the liquid discharge head 5. Furthermore, the driving mechanism 12 may be configured to adjust the position of the liquid discharge head 5 in the X and Y directions by driving the liquid discharge head 5 in the X and Y directions. In this embodiment, the inclination amount of the liquid discharge head 5 with respect to the scanning direction can be adjusted by rotationally driving the liquid discharge head 5 in the θZ direction by the driving mechanism 12, but the present disclosure is not limited to this. The inclination amount of the liquid discharge head 5 may be adjusted by rotationally driving the substrate 2 in the θZ direction by the substrate stage 3 or by relatively, rotationally driving the liquid discharge head 5 and the substrate 2 in the θZ direction by the driving mechanism 12 and the substrate stage 3.

When the substrate 2 is mounted on the substrate stage 3, a placement error may occur in the liquid supply apparatus 1. When the substrate 2 undergoes various manufacturing processes, shape distortion may occur in the X and Y directions in the substrate 2. To cope with this, the liquid supply apparatus 1 includes an alignment scope 9 that measures the position of the substrate 2 and the distortion amount of the substrate 2. To perform alignment measurement for the entire surface of the substrate 2, the alignment scope 9 and the substrate stage 3 are relatively driven in the X and Y directions. There are variations in thickness of the substrate 2 mounted on the substrate stage 3. Thus, if the liquid discharge head 5 is caused to discharge the droplets 4 while relatively scanning the liquid discharge head 5 and the substrate 2 in the scanning direction (Y direction), the adhesion positions (landing positions) of the droplets 4 on the substrate 2 may vary due to variations in thickness of the substrate 2. To cope with this, the liquid supply apparatus 1 can include a height sensor 10 that measures the position (height) of the substrate 2 in the Z direction. To perform height measurement for the entire surface of the substrate 2, the height sensor 10 and the substrate stage 3 are relatively driven in the X and Y directions.

The controller 11 is formed by a computer (information processing apparatus) that includes a processor such as a Central Processing Unit (CPU) and a storage unit such as a memory, and comprehensively controls patterning on the substrate 2 by controlling the respective units of the liquid supply apparatus 1. The controller 11 may be formed by, for example, a Programmable Logic Device (PLD) such as an FPGA (an abbreviation of Field Programmable Gate Array), an ASIC (an abbreviation of Application Specific Integrated Circuit), a general-purpose computer in which a program is installed, or a combination of all or some of them.

### [Operation Sequence of Liquid Supply Apparatus]

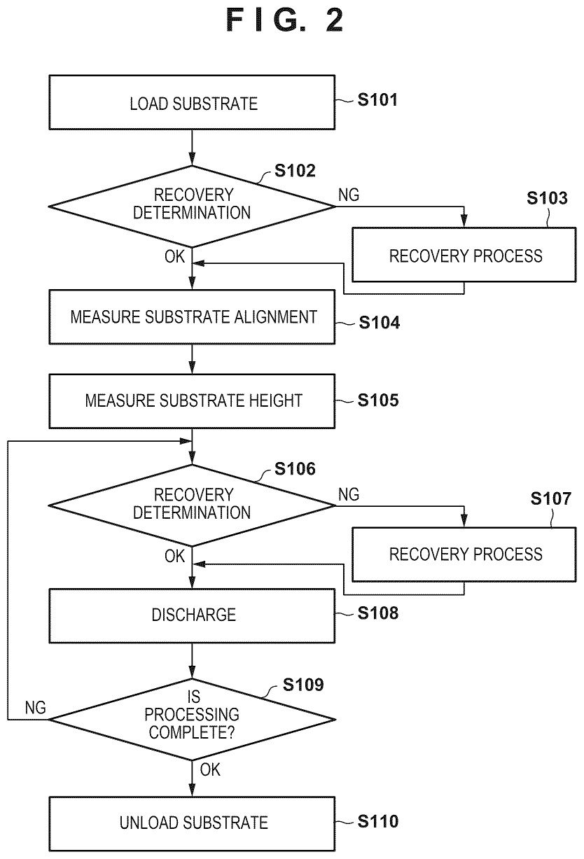

The operation sequence of the liquid supply apparatus 1 according to this embodiment will be described with reference to FIG. 2. In step S101, the controller 11 loads the substrate 2 into the liquid supply apparatus 1 by controlling a substrate conveyance apparatus. More specifically, the controller 11 loads the substrate 2 onto the substrate stage 3 by controlling the substrate conveyance apparatus, thereby causing the substrate stage 3 to hold the substrate 2. Next, in step S102, the controller 11 performs recovery determination of each nozzle 51 of the liquid discharge head 5. In the recovery determination, it is determined whether a discharge error occurs in each nozzle 51 of the liquid discharge head 5, that is, whether it is necessary to perform a recovery process for each nozzle 51. If there is the nozzle 51 for which a discharge error is determined in the recovery determination, the process advances to step S103, and the controller 11 executes a recovery process for respective nozzles 51 of the liquid discharge head 5. The recovery process can include a process of recovering the discharge characteristic of the liquid discharge head 5 by causing the recovery unit 8 to perform a cleaning process and the like for the liquid discharge head 5 (discharge surface 5a).

In step S104, the controller 11 performs alignment measurement of the substrate 2 by controlling the substrate stage 3 and the alignment scope 9. In step S105, the controller 11 performs height measurement of the substrate 2 by controlling the substrate stage 3 and the height sensor 10. Note that the order of alignment measurement of step S104 and the height measurement of step S105 may be reversed. Information concerning the position, distortion amount, and height of the substrate 2 obtained by alignment measurement and height measurement is stored in, for example, a memory of the controller 11. The controller 11 obtains discharge control information based on pixel data including information of the arrangement, size, and the like of pixels formed on the substrate. The discharge control information includes information indicating the target supply distribution of the droplets 4 in the pixel area 201 or the evaluation area 202 on the substrate 2.

In step S106, the controller 11 performs recovery determination of each nozzle 51 of the liquid discharge head 5. If there is the nozzle 51 for which a discharge error is determined in the recovery determination, the process advances to step S107, and the controller 11 executes a recovery process for each nozzle 51 of the liquid discharge head 5. Steps S106 and S107 are the same as steps S102 and S103 described above.

In step S108, the controller 11 controls a discharge process based on the target supply distribution to form a number of functional elements on the substrate 2 using the liquid supply apparatus 1. As described above, the discharge process is a process of causing the liquid discharge head 5 (each discharge outlet 51) to discharge the droplet 4 while relatively scanning the liquid discharge head 5 and a substrate 2 in a scanning direction (Y direction). In this embodiment, the liquid discharge head 5 and the substrate 2 can relatively be scanned by moving the substrate 2 by the substrate stage 3. However, the liquid discharge head 5 and the substrate 2 may relatively be scanned by moving the liquid discharge head 5 by the driving mechanism 12 or by relatively moving the liquid discharge head 5 and the substrate 2 by the driving mechanism 12 and the substrate stage 3.

In step S109, the controller 11 determines whether the discharge process is complete for the substrate 2. If the discharge process is incomplete for the substrate 2, the process returns to step S106. If the discharge process is complete for the substrate 2, the process advances to step S110. In step S110, the controller 11 unloads the substrate 2 from the liquid supply apparatus 1 (substrate stage 3) by controlling the substrate conveyance apparatus.

### [Configuration of Liquid Discharge Head]

The liquid supply apparatus 1 is utilized to manufacture display devices of various resolutions. Therefore, the liquid supply apparatus 1 inclines the liquid discharge head 5 with respect to the scanning direction and changes the pitch of the nozzles 51 in a non-scanning direction, thereby adjusting the pitch (that is, the resolution) of the droplets 4 in the non-scanning direction, which are supplied onto the substrate 2 in the discharge process. Note that if an angle at which the liquid discharge head 5 is inclined with respect to the scanning direction is not taken into consideration, it is impossible to arrange the nozzles 51 at equal intervals in the non-scanning direction, and it may become difficult to arrange the droplets 4 at equal intervals on the substrate 2. That is, unevenness may occur in supply of the droplets 4 on the substrate 2. Therefore, in this embodiment, the liquid discharge head 5 is configured (designed) so that the nozzles 51 are arranged at equal intervals in the non-scanning direction with each of a plurality of desired pitches in accordance with the angle (posture) at which the liquid discharge head 5 is inclined with respect to the scanning direction. Note that the non-scanning direction can be defined as a direction (predetermined direction or X direction) orthogonal to the scanning direction within the plane parallel to the discharge surface 5a of the liquid discharge head 5.

An example of the configuration of the liquid discharge head 5 according to this embodiment will be described below with reference to FIGS. 3A and 3B. FIGS. 3A and 3B are views of the discharge surface 5a of the liquid discharge head 5 when viewed from above as transparent views, and each show an example of the arrangement of the nozzles 51 on the discharge surface 5a.

In the liquid discharge head 5 according to this embodiment, m nozzle arrays 52 are provided on the discharge surface 5a. Each nozzle array 52 is formed by arraying, at a pitch A (distance A) in one direction D₁ (linearly), the plurality of nozzles 51 each for discharging the droplet 4. In addition, the m nozzle arrays 52 are arranged on the discharge surface 5a while being shifted in the one direction D₁ by a first distance d₁ (d₁=A/m) and in a direction D₂ perpendicular to the one direction D₁ by a second distance d₂. An example in which four (that is, m=4) nozzle arrays 52a to 52d are provided on the discharge surface 5a will be described with reference to FIGS. 3A and 3B. However, the number of nozzle arrays 52 provided on the discharge surface 5a is not limited to four, and need only be two or more. Furthermore, each nozzle array 52 may be understood as a discharge outlet array formed by arraying, at the pitch A in the one direction D₁, a plurality of discharge outlets each for discharging the droplet 4.

FIG. 3A shows an example of the arrangement of the nozzles 51 when the posture of the liquid discharge head 5 in the rotation direction (θZ direction) within the plane parallel to the discharge surface 5a is set to a first posture. In the first posture, the array direction (one direction D₁) of the nozzles 51 in each nozzle array 52 is parallel to the non-scanning direction (X direction). In this case, in all the m nozzle arrays, the nozzles 51 are arranged at equal intervals in the non-scanning direction. A pitch p₁ with which the nozzles 51 are arranged at equal intervals in the non-scanning direction in the first posture is equal to the first distance d₁.

FIG. 3B shows an example of the arrangement of the nozzles 51 when the posture of the liquid discharge head 5 in the rotation direction (θZ direction) within the plane parallel to the discharge surface 5a is set to a second posture. In the second posture, in the rotation direction within the plane parallel to the discharge surface 5a, the array direction (one direction D₁) of the nozzles 51 in each nozzle array 52 is inclined at an angle θ with respect to the non-scanning direction (X direction). The angle θ is decided so as to satisfy Equation (1), below. In this case as well, in all the m nozzle arrays 52, the nozzles 51 are arranged at equal intervals in the non-scanning direction. A pitch p₂ with which the nozzles 51 are arranged at equal intervals in the non-scanning direction in the second posture is given by Equation (2), below. In Equation (1), “n” represents a natural number (n=1, 2, 3, . . .) and “θ” is not zero or an integer multiple of π/2.

d₂=2n·d₁/tan θ (1)

p₂=p₁·cosθ (2)

The angle θ is selected within a range of 5° to 10°, and the natural number n is selected within a range of 2 to 4. As an example, assume that the resolution in the non-scanning direction is 600 dpi, the number of nozzle arrays 52 is four, and the angle θ is 10°. The resolution in the non-scanning direction may be understood as an index representing the pitch of the droplets 4 in the non-scanning direction, which should be supplied onto the substrate 2. In this case, the pitch p₁ of the nozzles 51 in the first posture can be set to 42.3 μm, and the pitch p₂ of the nozzles 51 in the second posture can be set to 41.7 μm which is smaller than the pitch p₁ by cos θ. In addition, it is possible to set the second distance d₂ to a distance n times larger than 480.2 μm. However, if “n” is too small, it becomes difficult to create the liquid discharge head 5, and if “n” is too large, the size of the liquid discharge head 5 may become large.

As described above, in a case where the liquid discharge head 5 according to this embodiment is in the first posture in which the array direction of the nozzles 51 in each nozzle array 52 is parallel to the non-scanning direction, the nozzles 51 are arranged at equal intervals with the pitch p₁ (p₁=d₁) in the non-scanning direction. That is, by performing the discharge process in the first posture, it is possible to supply the droplets 4 onto the substrate 2 at equal intervals with the pitch p₁ in the non-scanning direction. In a case where the liquid discharge head 5 according to this embodiment is in the second posture in which the array direction of the nozzles 51 in each nozzle array 52 is inclined at the angle θ with respect to the non-scanning direction, the nozzles 51 are arranged at equal intervals with the pitch p₂ (p₂=p₁·cos θ) in the non-scanning direction. That is, by performing the discharge process in the second posture, it is possible to supply the droplets 4 onto the substrate 2 at equal intervals with the pitch p₂ in the non-scanning direction. Therefore, the liquid discharge head 5 according to this embodiment can accurately supply the droplets 4 onto the substrate 2 at equal intervals in the non-scanning direction with each of a plurality of desired pitches, thereby reducing unevenness in supply of the droplets 4 on the substrate.

The first posture and the second posture have been exemplified above as the posture of the liquid discharge head 5 in which the nozzles 51 are arranged at equal intervals in the non-scanning direction, but the posture is not limited to these two postures and the number of postures may be three or more. The posture of the liquid discharge head 5 may be decided by the controller 11. The controller 11 can decide the angle θ, at which the driving mechanism 12 rotationally drives the liquid discharge head 5 in the θZ direction to change the pitch of the nozzles 51 in the non-scanning direction, so as to satisfy Equation (1), above. For example, the angle θ can be decided based on resolution information representing the resolution in the non-scanning direction. The liquid supply apparatus 1 is provided with a user interface (display unit and input unit), and a plurality of resolutions can be displayed in a selection form on the display unit. The plurality of resolutions are each set to a resolution that is obtained in the posture of the liquid discharge head 5 satisfying Equation (1), above, and include a resolution obtained by the liquid discharge head 5 in the first posture and a resolution obtained by the liquid discharge head 5 in the second posture. Thus, the controller 11 can obtain, as resolution information, the resolution selected from the plurality of resolutions by the user via the input unit, and decide, based on the resolution information, the posture of the liquid discharge head 5 so as to satisfy Equation (1), above.

### Second Embodiment

The second embodiment of the present disclosure will be described. Since a vibration occurs in each nozzle 51 of a liquid discharge head 5 due to discharge of a droplet 4, if the vibration influences another nozzle 51, it can be difficult to accurately supply the droplet 4 from the other nozzle 51 onto a substrate 2. This phenomenon is sometimes called crosstalk. In this embodiment, based on arrangement information (for example, design data) indicating the arrangement of a plurality of target regions on the substrate 2, the posture of the liquid discharge head 5 in a discharge process is decided so as to reduce the influence of crosstalk. An example in which the posture of the liquid discharge head 5 in a discharge process is selected from the first posture and the second posture based on the arrangement information so as to reduce the influence of crosstalk will be described below. For conciseness, the description of the second embodiment incorporates by reference description of components and steps of the first embodiment, except as disclosed below.

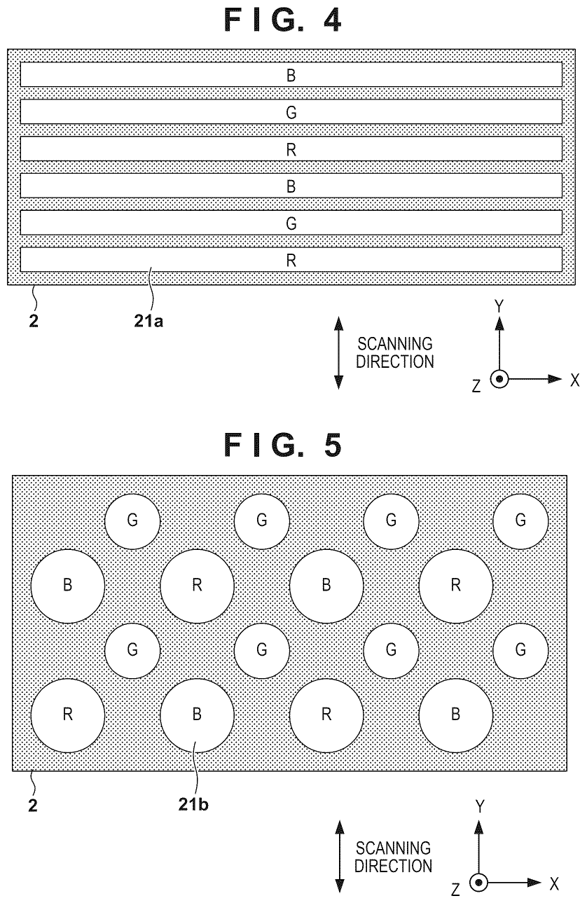

Each of FIGS. 4 and 5 shows an example of the arrangement of a plurality of target regions 21 on the substrate 2. Each target region 21 is a region (pixel region) where the droplet 4 is to be supplied to form a pixel on the substrate 2. The plurality of target regions 21 can be classified into pixel regions of three colors of R, G, and B (Red, Green, and Blue). In FIGS. 4 and 5, each target region is assigned with “R”, “G”, or “B” to represent a type of a pixel that is formed in the region.

FIG. 4 shows an example in which a plurality of target regions 21a extending in a non-scanning direction (X direction) as a longitudinal direction are arranged on the substrate 2 along a scanning direction (Y direction). Each target region 21a is formed in, for example, a rectangular shape, and the target regions 21a of R, G, and B are repeatedly arranged in the scanning direction. FIG. 5 shows an example in which a plurality of target regions 21b whose pixel sizes and inter-pixel distances are different for R, G, and B are arranged on the substrate 2. Each target region 21b can be formed in, for example, a circular shape. In this example, in a case where it is necessary to supply the droplets 4 of three colors of R, G, and B to the respective target regions 21 as on the substrate 2 shown in each of FIGS. 4 and 5, the liquid supply apparatus 1 can be provided with three types of liquid discharge heads 5 for discharging the droplets 4 (inks) of different colors. The three types of liquid discharge heads 5 can be arranged in, for example, the non-scanning direction (X direction).

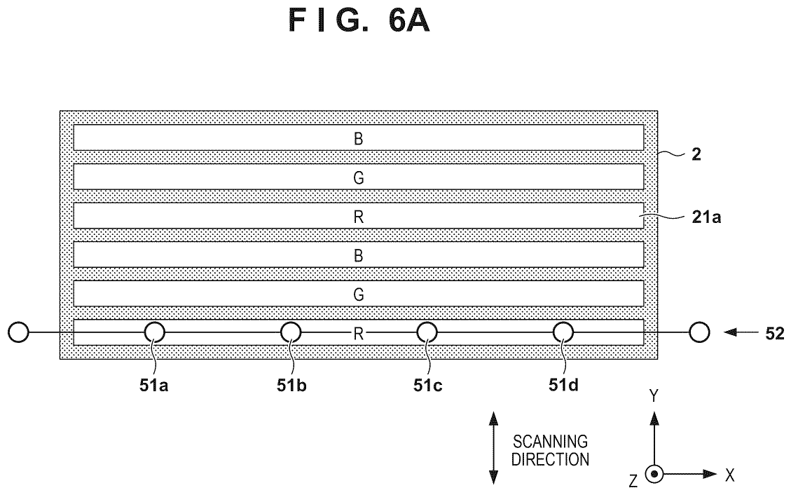

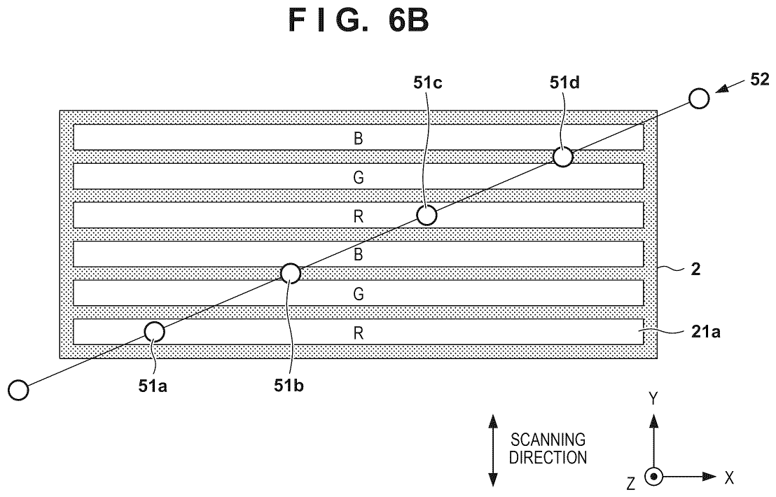

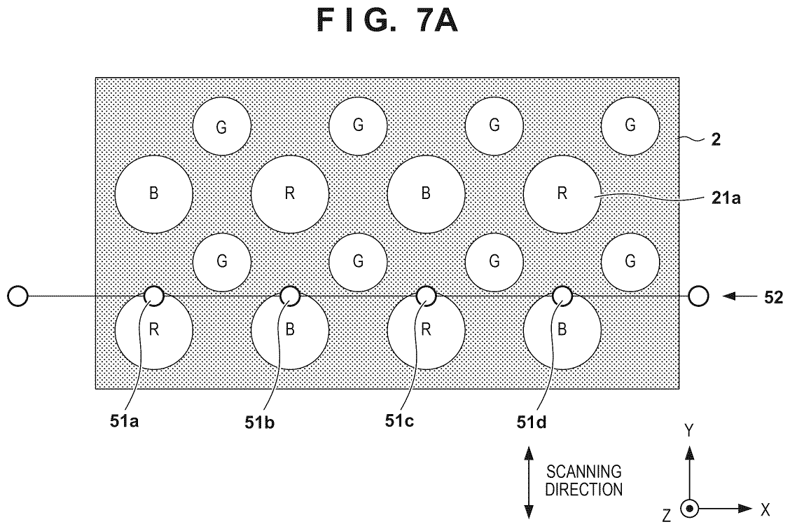

With respect to the substrate 2 shown in each of FIGS. 4 and 5, the influence of crosstalk when performing a discharge process by the liquid discharge head 5 in the first posture and when performing a discharge process by the liquid discharge head 5 in the second posture will be described below with reference to FIGS. 6A and 6B, FIGS. 7A and 7B, and FIGS. 8A and 8B.

FIGS. 6A and 6B each show an example in which a discharge process is performed using the liquid discharge head 5 for the target regions 21a of the R pixels on the substrate 2 shown in FIG. 4. FIGS. 6A and 6B each show only one nozzle array 52 in the liquid discharge head 5. The one nozzle array 52 includes nozzles 51a to 51d.

FIG. 6A shows a state in which a discharge process is performed using the liquid discharge head 5 in the first posture for the target regions 21a of the R pixels on the substrate 2. As described above, the first posture is the posture of the liquid discharge head 5 when the array direction of the nozzles 51 in the nozzle array 52 is parallel to the non-scanning direction. In this case, since all the nozzles 51a to 51d are arranged on the target region 21a of the R pixel, the droplets 4 are discharged from the nozzles 51a to 51d at the same timing in the discharge process. That is, the nozzles 51a to 51d, especially, the nozzles 51 adjacent to each other are largely influenced by crosstalk. As a result, it becomes difficult to accurately supply the droplets 4 onto the substrate 2, thereby causing unevenness in supply of the droplets 4 on the substrate 2.

FIG. 6B shows a state in which a discharge process is performed using the liquid discharge head 5 in the second posture for the target regions 21a of the R pixels on the substrate 2. As described above, the second posture is the posture of the liquid discharge head 5 when the array direction of the nozzles 51 in the nozzle array 52 is inclined at an angle θ with respect to the non-scanning direction. In this case, among the nozzles 51a to 51d, the nozzles arranged on the target regions 21a of the R pixels are only the nozzles 51a and 51c. That is, the nozzles 51 that are adjacent to each other and are largely influenced by crosstalk do not discharge the droplets 4 at the same timing.

Therefore, in the arrangement of the plurality of target regions 21a shown in FIG. 4, by inclining the array direction of the nozzles 51 with respect to the non-scanning direction, as shown in FIG. 6B, it is possible to increase the distance between the nozzles that discharge the droplets 4 at the same timing. That is, it is possible to reduce the influence of crosstalk. In addition, as described in the first embodiment, by inclining the array direction of the nozzles 51 at the “angle θ” with respect to the non-scanning direction, it is possible to arrange the nozzles 51 at equal intervals in the non-scanning direction in all the m nozzle arrays 52. That is, with respect to each target region 21a on the substrate 2, it is possible to supply the droplets 4 at equal intervals in the non-scanning direction, thereby reducing unevenness in supply of the droplets 4 on the substrate 2. Note that on the substrate 2 shown in FIG. 4, the target regions 21 a of the G pixels and the target regions 21a of the B pixels are similar to the target regions 21a of the R pixels.

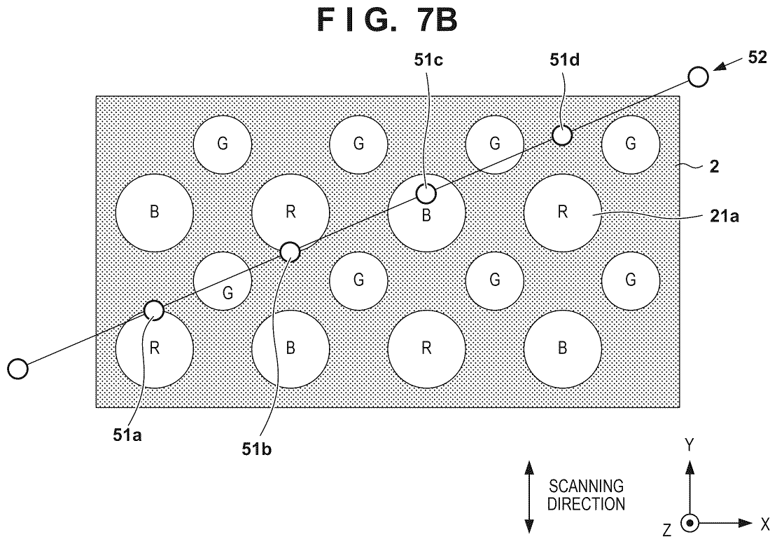

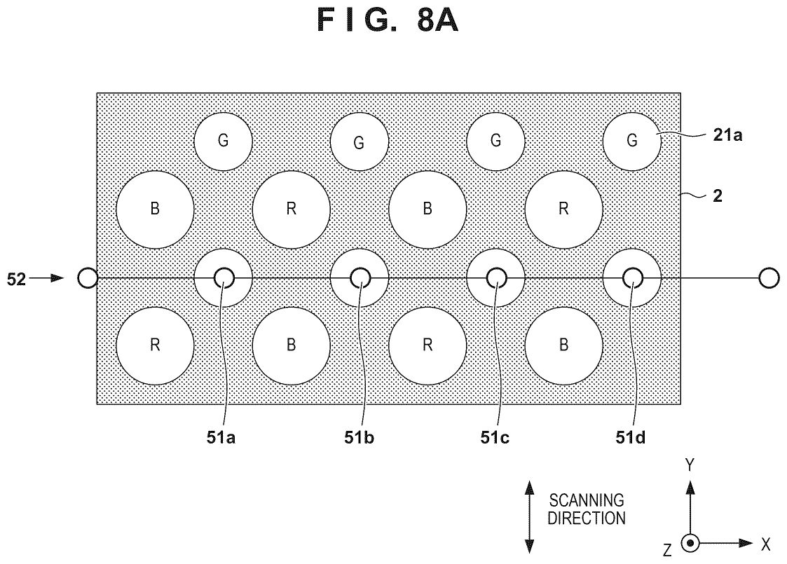

FIGS. 7A and 7B each show an example in which a discharge process is performed using the liquid discharge head 5 for the target regions 21b of the R pixels on the substrate 2 shown in FIG. 5. Similar to FIGS. 6A and 6B, FIGS. 7A and 7B each show only one nozzle array 52 in the liquid discharge head 5. The one nozzle array 52 includes the nozzles 51a to 51d.

FIG. 7A shows a state in which a discharge process is performed using the liquid discharge head 5 in the first posture for the target regions 21b of the R pixels on the substrate 2. In this case, among the nozzles 51a to 51d, the nozzles arranged on the target regions 21b of the R pixels are only the nozzles 51a and 51c. That is, the nozzles 51 that are adjacent to each other and are largely influenced by crosstalk do not discharge the droplets 4 at the same timing.

FIG. 7B shows a state in which a discharge process is performed using the liquid discharge head 5 in the second posture for the target regions 21b of the R pixels on the substrate 2. In this case, the nozzles 51a and 51b adjacent to each other are largely influenced by crosstalk because the timings of discharging the droplets 4 are close to each other.

Therefore, in the arrangement of the target regions 21b of the R pixels shown in FIG. 5, by making the array direction of the nozzles 51 parallel to the non-scanning direction, as shown in FIG. 7A, it is possible to increase the distance between the nozzles that discharge the droplets 4 at the same timing. That is, it is possible to reduce the influence of crosstalk. Note that on the substrate 2 shown in FIG. 5, the target regions 21b of the B pixels are similar to the target regions 21b of the R pixels.

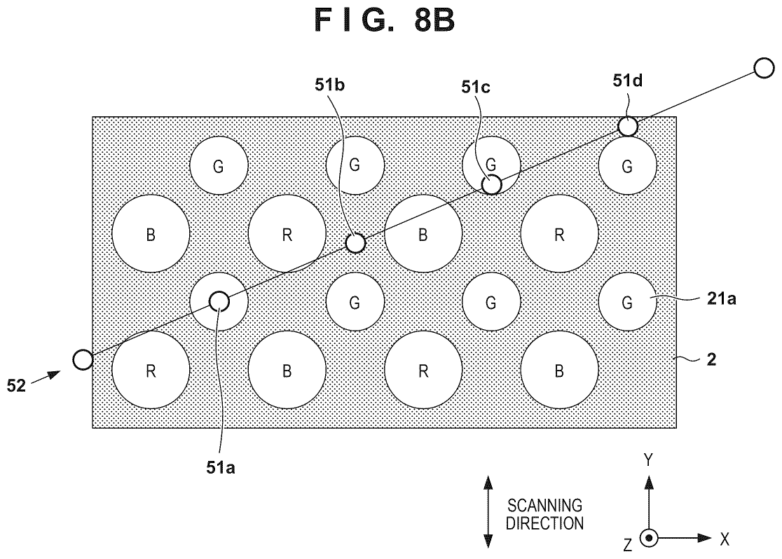

On the other hand, depending on the arrangement of the target regions 21 of the pixels of a color different from the R pixels, the influence of crosstalk may be reduced more in a case where the array direction of the nozzles 51 is inclined with respect to the non-scanning direction than in a case where the array direction of the nozzles 51 is parallel to the non-scanning direction. FIGS. 8A and 8B each show an example in which a discharge process is performed using the liquid discharge head 5 for the target regions 21b of the G pixels on the substrate 2 shown in FIG. 5. Similar to FIGS. 6A and 6B and FIGS. 7A and 7B, FIGS. 8A and 8B each show only one nozzle array 52 in the liquid discharge head 5. The one nozzle array 52 includes the nozzles 51a to 51d.

FIG. 8A shows a state in which a discharge process is performed using the liquid discharge head 5 in the first posture for the target regions 21b of the G pixels on the substrate 2. In this case, since all the nozzles 51a to 51d are arranged on the target regions 21b of the G pixels, the nozzles 51a to 51d discharge the droplets 4 at the same timing in the discharge process. That is, the nozzles 51a to 51d, especially, the nozzles 51 adjacent to each other are largely influenced by crosstalk. As a result, it becomes difficult to accurately supply the droplets 4 onto the substrate 2, thereby causing unevenness in supply of the droplets 4 on the substrate 2.

FIG. 8B shows a state in which a discharge process is performed using the liquid discharge head 5 in the second posture for the target regions 21b of the G pixels on the substrate 2. In this case, among the nozzles 51a to 51d, the nozzles arranged on the target regions 21b of the G pixels are only the nozzles 51a and 51c. That is, the nozzles 51 that are adjacent to each other and are largely influenced by crosstalk do not discharge the droplets 4 at the same timing.

Therefore, in the arrangement of the target regions 21b of the G pixels shown in FIG. 5, by inclining the array direction of the nozzles 51 with respect to the non-scanning direction, as shown in FIG. 8B, it is possible to increase the distance between the nozzles that discharge the droplets 4 at the same timing. That is, it is possible to reduce the influence of crosstalk. In addition, as described in the first embodiment, by inclining the array direction of the nozzles 51 at the “angle θ” with respect to the non-scanning direction, it is possible to arrange the nozzles 51 at equal intervals in the non-scanning direction in all the m nozzle arrays 52, thereby reducing unevenness in supply of the droplets 4 on the substrate 2.

As described above, depending on the arrangement of the plurality of target regions 21 on the substrate 2, the posture of the liquid discharge head 5 that can reduce the influence of crosstalk in the discharge process may be the first posture or the second posture. Therefore, a controller 11 according to this embodiment decides the posture of the liquid discharge head 5 in the discharge process based on the arrangement information. For example, the controller 11 selects the posture of the liquid discharge head 5 in the discharge process from the first posture and the second posture based on the arrangement information, and controls the driving mechanism 12 to set the selected posture. This can reduce the influence of crosstalk generated during the discharge process, and accurately supply droplets onto the substrate 2.

### Third Embodiment

The third embodiment of the present disclosure will be described. For conciseness, the description of the third embodiment incorporates by reference description of components and steps of the first embodiment and the second embodiment, except as disclosed below.

The above first embodiment has explained an example in which the array direction of the nozzles 51 with respect to the non-scanning direction is changed, as shown in FIGS. 3A and 3B, by rotationally driving the liquid discharge head 5 in the θZ direction by the driving mechanism 12. However, on a discharge surface 5a of the liquid discharge head 5, both a first nozzle group formed by m nozzle arrays 52 shown in FIG. 3A and a second nozzle group formed by m nozzle arrays 52 shown in FIG. 3B may be provided. The first nozzle group and the second nozzle group are inclined relative to each other at an angle θ, and the angle θ satisfies Equation (1), above. The first nozzle group and the second nozzle group may be provided on the same chip or different chips on the discharge surface 5a of the liquid discharge head 5. Note that the first nozzle group may be understood as a first discharge outlet group formed by m discharge outlet arrays, and the second nozzle group may be understood as a second discharge outlet group formed by m discharge outlet arrays.

As described above, the liquid discharge head 5 is provided with the first nozzle group and the second nozzle group. The first nozzle group is a nozzle group in which the array direction of nozzles 51 in each nozzle array 52 is parallel to the non-scanning direction, and the second nozzle group is a nozzle group in which the array direction of nozzles 51 in each nozzle array 52 is inclined at the angle θ with respect to the non-scanning direction. In this case, based on arrangement information, a controller 11 selects, from the first nozzle group and the second nozzle group, a nozzle group to be used for a discharge process so as to reduce the influence of crosstalk. A method of selecting a nozzle group is the same as the method of selecting the posture of the liquid discharge head 5 described in the second embodiment, and a description thereof will be omitted.

### Article Manufacture Method

An article manufacturing method according to an embodiment of the present disclosure is suitable for manufacturing an article, for example, a display panel such as an organic EL display, a microdevice such as a semiconductor device, or an element having a fine structure. The article manufacturing method according to the embodiment includes a supply step of supplying a liquid onto a substrate using the above-described liquid supply apparatus (liquid supply method), a processing step of processing the substrate onto which the liquid has been supplied in the supply step, and a step of manufacturing an article from the substrate processed in the processing step. In addition, the article manufacturing method includes other well-known steps (calcination, cooling, cleaning, oxidation, deposition, vapor deposition, doping, planarization, etching, resist removal, dicing, bonding, packaging, and the like). The article manufacturing method according to this embodiment is more advantageous than the conventional methods in at least one of the performance, quality, productivity, and production cost of the article.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-209750, filed on Dec. 2, 2024, which is hereby incorporated by reference herein in its entirety.

What is claimed is:

1. A liquid discharge head including a discharge surface, the liquid discharge head comprising:
m discharge outlet arrays provided on the discharge surface, wherein: each discharge outlet array is formed by arraying, at a pitch A in one direction, a plurality of discharge outlets each configured to discharge liquid as respective droplets,
the m discharge outlet arrays are arranged while being shifted in the one direction by a first distance d₁, in a direction perpendicular to the one direction by a second distance d₂,
in each of a first posture in which the one direction is parallel to a predetermined direction and a second posture in which the one direction is inclined at an angle θ with respect to the predetermined direction, the discharge outlets across the m discharge outlet arrays are arranged at equal intervals in the predetermined direction,
d₁=A/m, and
d₂=2n·d₁/tan θ.

2. The liquid discharge head according to claim 1, wherein:
in a process of supplying the liquid onto a substrate, the liquid discharge head is controlled to discharge the droplets in a state in which the liquid discharge head and the substrate are relatively scanned in a scanning direction, and
the predetermined direction is a direction perpendicular to the scanning direction.

3. The liquid discharge head according to claim 1, wherein:
p₂=p₁·cos θ,
with p1 being a pitch with which the discharge outlets are arranged at the equal intervals in the predetermined direction in the first posture, and
p₂ being a pitch which the discharge outlets are arranged at the equal intervals in the predetermined direction in the second posture.

4. The liquid discharge head according to claim 3, wherein:
p₁=d₁.

5. The liquid discharge head according to claim 1, wherein the angle θ is within a range of 5° to 10°.

6. The liquid discharge head according to claim 1, wherein n is a natural number within a range of 2 to 4.

7. A liquid supply apparatus for supplying a liquid to each target region of a plurality of target regions on a substrate, the liquid supply apparatus comprising:
a liquid discharge head according to claim 1; and
a controller configured to:
control the liquid discharge head to discharge the respective droplets while relatively scanning the liquid discharge head and the substrate in a scanning direction, and
select one from the first posture and the second posture based on information indicating an arrangement of the plurality of target regions on the substrate.

8. The liquid supply apparatus according to claim 7, further comprising a driving mechanism configured to rotationally drive the liquid discharge head within a plane parallel to the discharge surface,
wherein the controller is further configured to control the driving mechanism to set the posture of the liquid discharge head to the selected one from the first posture and the second posture based on the information.

9. An article manufacturing method comprising:
supplying a liquid onto a substrate using a liquid supply apparatus according to claim 7;
processing the substrate onto which the liquid has been supplied; and
manufacturing an article from the processed substrate.

10. A liquid discharge head including a discharge surface, the liquid discharge head comprising:
a first discharge outlet group; and
a second discharge outlet group, wherein:
each of the first discharge outlet group and the second discharge outlet group are formed by m discharge outlet arrays provided on the discharge surface,
each discharge outlet array is formed by arraying, at a pitch A in one direction, a plurality of discharge outlets each configured to discharge liquid as respective droplets,
the m discharge outlet arrays are arranged while being shifted in the one direction by a first distance d₁, in a direction perpendicular to the one direction by a second distance d₂,
the first discharge outlet group and the second discharge outlet group are inclined relative to each other at an angle θ,
d₁=A/m, and
d₂=2n·1/tan θ, with n being a natural number.

11. A liquid supply apparatus for supplying liquid to each target region of a plurality of target regions on a substrate, the liquid supply apparatus comprising:
a liquid discharge head according to claim 10; and
a controller configured to:
control the liquid discharge head to discharge the respective droplets while relatively scanning the liquid discharge head and the substrate in a scanning direction, and
select one from the first discharge outlet group and the second discharge outlet group based on information indicating an arrangement of the plurality of target regions on the substrate.

12. A method of manufacturing an article, the method comprising:
supplying a liquid onto a substrate using a liquid supply apparatus according to claim 11;
processing the substrate onto which the liquid has been supplied; and
manufacturing an article from the processed substrate.

13. A liquid discharge head comprising:
a plurality of outlet arrays each configured to discharge a liquid as a droplet, wherein: the plurality of outlet arrays are formed at a pitch in a first direction,
the plurality of outlet arrays are shifted in the first direction by a first distance d₁ and in a second direction perpendicular to the first direction, and
in a first posture and a second posture, a predetermined number of outlet arrays are arranged at equal intervals in a predetermined direction.

14. The liquid discharge head according to claim 13, wherein the second direction is shifted perpendicular to the first direction by a second distance d₂.

15. The liquid discharge head according to claim 13, wherein, in the first posture, the first direction is parallel to the predetermined direction.

16. The liquid discharge head according to claim 13, wherein, in the second posture, the first direction is inclined at an angle θ with respect to the predetermined direction.

17. The liquid discharge head according to claim 16, wherein d₂=2n·d₁/tan θ.

18. The liquid discharge head according to claim 17, wherein n is a natural number.

19. The liquid discharge head according to claim 13, wherein:
d₁=A/m,
with A corresponding to the pitch in the first direction and m corresponding to a number of outlet arrays.
